(19) United States
(12) Patent Application Publication
(10) Pub. No.: US 2023/0249164 A1
(43) Pub. Date: Aug. 10, 2023

(54) Zeolite-Containing SCR Catalyst

(71) Applicant: BASF CORPORATION, Florham Park, NJ (US)

(72) Inventor: Wen-Mei Xue, Dayton, NJ (US)

(73) Assignee: BASF CORPORATION, Florham Park, NJ (US)

(21) Appl. No.: 18/010,222

(22) PCT Filed: Jun. 24, 2021
(86) PCT No.: PCT/US2021/038953

§ 371 Date: Dec. 14, 2022

Related U.S. Application Data
(60) Provisional application No. 63/044,053, filed on Jun. 25, 2020.

(51) Int. Cl. B01J 29/76; B01D 53/94; B01J 35/04; B01J 37/04; B01J 35/02

(52) U.S. Cl. CPC B01J 29/763; B01D 53/9418; B01J 35/04; B01J 37/04; B01J 35/026

(57) ABSTRACT

The present disclosure provides a selective catalytic reduction (SCR) catalyst composition prepared from a first un-promoted zeolite having a first silica-to-alumina ratio (SAR) from about 5 to about 100, a promoter precursor, and a second un-promoted zeolite having a second silica-to-alumina ratio (SAR) from about 5 to about 100. The present disclosure further provides a method of forming the SCR catalyst composition, a catalytic article comprising the SCR catalyst composition, an engine exhaust gas treatment system comprising the SCR catalyst composition, and a method of removing nitrogen oxides from exhaust gas from a lean burn engine using the SCR catalyst composition.

This application claims the benefit of priority to U.S. Provisional Application No. 63/044,053, filed Jun. 25, 2020, the contents of which are incorporated by reference herein in their entirety.

The present disclosure relates to zeolite-containing SCR catalyst compositions, methods for preparing and using such catalyst compositions for emission control applications, and catalyst articles and systems employing such catalyst compositions.

Over time, the harmful components of nitrogen oxides (NOₓ) have led to atmospheric pollution. NOₓ is contained in exhaust gases, such as from internal combustion engines (e.g., in automobiles and trucks), from combustion installations (e.g., power stations heated by natural gas, oil, or coal), and from nitric acid production plants.

Various treatment methods have been used for the treatment of NOₓ-containing gas mixtures to decrease atmospheric pollution. One type of treatment involves catalytic reduction of nitrogen oxides. There are two processes: (1) a nonselective reduction process where carbon monoxide, hydrogen, or a hydrocarbon is used as a reducing agent; and (2) a selective reduction process where ammonia or an ammonia precursor is used as a reducing agent. In the selective reduction process, a high degree of nitrogen oxide removal can be achieved with a stoichiometric amount of reducing agent.

The selective reduction process is referred to as a Selective Catalytic Reduction (SCR) process. The SCR process uses catalytic reduction of nitrogen oxides with a reductant (e.g., ammonia) in the presence of excess oxygen, resulting in the formation predominantly of nitrogen and steam:

4NO+4NH₃+O₂→4N₂+6H₂O (standard SCR reaction)

2NO₂+4NH₃+O₂→3N₂+6H₂O (slow SCR reaction)

NO+NO₂+2NH₃→2N₂+3H₂O (fast SCR reaction)

Catalysts employed in the SCR process can retain good catalytic activity over a wide range of temperature conditions of use, for example, 200° C. to 600° C. or higher, under hydrothermal conditions. SCR catalysts used in exhaust emission control applications are exposed to high temperature hydrothermal conditions during the regeneration of a soot filter, which is a component of the exhaust gas treatment system used for the removal of particles.

Molecular sieves, such as zeolites, have been used in the SCR of nitrogen oxides with a reductant, such as ammonia, urea, or a hydrocarbon, in the presence of oxygen. Zeolites are crystalline materials having uniform pore sizes ranging from about 3 angstroms to about 10 angstroms in diameter, depending upon the type of zeolite and the type and amount of cations included in the ion exchange sites.

Metal-promoted zeolite catalysts are known to include, among others, iron-promoted and copper-promoted zeolite catalysts, for the selective catalytic reduction of nitrogen oxides with ammonia. For example, iron-promoted zeolite beta has been an effective commercial catalyst for the selective reduction of nitrogen oxides with ammonia, e.g., as described in U.S. Pat. No. 4,961,917.

There is a need for improved performance of catalysts. Accordingly, it would be beneficial to provide SCR catalysts with improved low and/or high temperature performance.

The present disclosure provides catalyst compositions comprising a selective catalytic reduction (SCR) catalyst composition prepared with a first un-promoted zeolite and a second un-promoted zeolite, wherein each of the first and second un-promoted zeolites are in H⁺ form, NH₄⁺ form, or a combination thereof. Although not intending to be limiting, it is believed that a metal component (e.g., a “promoter precursor”) incorporated within such catalyst composition can react in situ with the first and/or second un-promoted zeolite, thereby forming metal-promoted zeolites. Metal oxide clusters can pre-exist in as-made metal-promoted zeolite catalysts. The in situ promotion of the zeolites of the present disclosure leads to beneficial properties as will be described in further detail herein. For example, forming the metal-promoted zeolite in situ according to the present disclosure can eliminate or at least reduce metal oxide clusters present in the as-made catalyst composition, as compared to metal-promoted zeolite catalyst-containing compositions. Without being limiting, at least a portion of the first un-promoted zeolite becomes promoted with a metal during production of the catalyst composition, via exchange with the metal of the promoter precursor when mixed with the first un-promoted zeolite. In some embodiments, at least a portion of the second un-promoted zeolite remains in un-promoted form in the produced catalyst composition, such that the second zeolite can capture metal oxide clusters formed in hydrothermal conditions in the treated engine exhaust gas.

The catalyst compositions described herein can be disposed on a substrate. For example, the porous substrate can be a flow-through porous monolith or a wall-flow filter.

A method of forming a selective catalytic reduction (SCR) catalyst is also provided herein. The methods can further include preparing an SCR catalyst article by coating a porous substrate with the SCR catalyst compositions described herein.

These and other features, aspects, and advantages of the disclosure will be apparent from a reading of the following detailed description together with the accompanying drawings, which are briefly described below. The disclosure includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed disclosure, in any of its various aspects and embodiments, should be viewed as intended to be combinable unless the context clearly dictates otherwise.

### BRIEF DESCRIPTION OF THE DRAWINGS

To provide an understanding of embodiments of the disclosure, reference is made to the appended drawings, which are not necessarily drawn to scale, and in which reference numerals refer to components of example embodiments of the disclosure. The drawings are provided as examples only, and should not be construed as limiting the scope of the disclosure.

FIG. 1A depicts a perspective view of a honeycomb-type substrate which may comprise a catalyst composition, in accordance with some embodiments of the present disclosure.

FIG. 1B depicts a partial cross-sectional view enlarged relative to FIG. 1A and taken along a plane parallel to the end faces of the carrier of FIG. 1A, which shows an enlarged view of a plurality of the gas flow passages shown in FIG. 1A, in accordance with some embodiments of the present disclosure.

FIG. 2 depicts a cross-sectional view of a section of a wall flow filter substrate, in accordance with some embodiments of the present disclosure.

FIG. 3 depicts a schematic depiction of an embodiment of an emission treatment system using a catalyst disclosed in the present disclosure.

FIG. 4 depicts a graph of NOx conversion over a range of temperatures for SCR catalyst samples according to the present disclosure and for comparative SCR catalyst samples.

FIG. 5 depicts a graph of N₂O formation over a range of temperatures for catalyst samples according to the present disclosure and for comparative SCR catalyst samples.

FIG. 6 depicts a graph of NOx conversion over a range of temperatures for SCR catalyst samples according to the present disclosure and for comparative SCR catalyst samples.

FIG. 7 depicts a graph of N₂O formation over a range of temperatures for catalyst samples according to the present disclosure and for comparative SCR catalyst samples.

The present disclosure will now be described with reference to example embodiments thereof. The disclosure may be embodied in many different forms and should not be construed as limited to the embodiments set forth herein. As used in the specification, and in the appended claims, the singular forms “a”, “an”, “the”, include plural referents unless the context clearly dictates.

The present disclosure provides catalyst compositions, e.g., SCR catalyst compositions, suitable for at least partial conversion of NOₓ emissions from an engine, such as a diesel or a gasoline engine. The catalyst compositions are formed from one or more un-promoted molecular sieves (e.g., zeolites), a promoter precursor, and a binder, and can be prepared and coated onto a substrate using a washcoat technique as set forth below. As used herein, the term “un-promoted zeolite” refers to a zeolite that is in H⁺ form, NH₄⁺ form, or a combination of these forms (e.g., the zeolite has not been promoted with a metal component). It is noted that metal (e.g., copper) oxide clusters can advantageously react with an un-promoted zeolite component to form a metal-promoted zeolite, which is active for selective catalytic reduction of NOₓ Converting metal oxide clusters to exchanged metal ions in a zeolite reduces NH₃ oxidation activity, which accounts for improved NOₓ conversion at high temperatures and reduced N₂O formation.

The present disclosure recognizes that metal oxide (e.g., CuOₓ) clusters can be captured by an un-promoted zeolite component, and the captured metal oxide clusters can react with the un-promoted zeolite in situ to form a metal-promoted zeolite, which is active for selective catalytic reduction of NOₓ emissions. For example, an SCR catalyst composition produced from a first un-promoted zeolite and a copper-containing promoter precursor which react in situ to form a copper-promoted zeolite, and further including a second un-promoted zeolite, can provide improved high-temperature NOₓ conversion and reduced N₂O formation without compromising low-temperature NOₓ conversion. Furthermore, by including some un-promoted zeolite in the catalyst compositions described herein, copper oxide (CuOₓ) clusters formed during hydrothermal conditions in the engine can be captured and thereby converted to exchanged metal ions in the un-promoted zeolite for selective catalytic reduction of NOₓ.

Catalyst Composition

The catalyst compositions disclosed herein generally comprise a selective catalytic reduction (SCR) catalyst composition comprising a first copper-promoted molecular sieve (e.g., zeolite) formed from a first un-promoted molecular sieve (e.g., zeolite) and a promoter metal-containing compound (e.g., a copper-containing compound) which react in situ to form the first copper-promoted molecular sieve (e.g., zeolite), a binder (e.g., zirconium acetate), and a second un-promoted molecular sieve (e.g., zeolite). In various embodiments, the catalyst compositions described herein are substantially free of a metal-promoted zeolite when the components of the catalyst composition are initially combined. In some embodiments, copper ions can move and change their positions within a zeolite as temperature increases. See, e.g., Lee, Hwangho et al. Inter-particle migration of Cu ions in physically mixed Cu-SSZ-13 and H-SSZ-13 treated by hydrothermal aging, The Royal Society of Chemistry (2019), which is herein incorporated by reference. In the disclosed compositions, it is believed that the metal-containing (e.g., copper) particles can react with the un-promoted zeolite to provide SCR activity at high temperatures. See. e.g., the reaction mechanism described in Wang, Di, et al. Selective Catalytic Reduction of NOₓ with NH₃ over a Cu-SSZ-13 Catalyst Prepared by a Solid-State Ion-Erchange Method, ChemCatChem (2014), 6, 1579-1583, which is herein incorporated by reference in its entirety. The SCR catalyst composition according to the present disclosure can exhibit improved NOₓ conversion at high temperature and/or reduced N₂O formation, as compared with a comparable composition without a metal-promoted zeolite formed from a first un-promoted zeolite and a promoter precursor which react in situ, and a second un-promoted zeolite.

The phrase “molecular sieve,” as used herein refers to framework materials such as zeolites and other framework materials (e.g., isomorphously substituted materials), which may be used, e.g., in particulate form, in combination with one or more promoter metals, as catalysts. Molecular sieves are materials based on an extensive three-dimensional network of oxygen ions containing generally tetrahedral type sites and having a substantially uniform pore distribution, with the average pore size being no larger than 20 Å. The pore sizes are defined by the ring size. As used herein, the term “zeolite” refers to a specific example of a molecular sieve, further including silicon (Si) and aluminum (Al) atoms. According to one or more embodiments, it will be appreciated that defining the molecular sieves by their structure type is intended to include both molecular sieves having that structure type, and isotypic framework materials, such as SAPO, AlPO and MeAPO materials, having the same structure type.

In some embodiments, an aluminosilicate zeolite structure type material for molecular sieves do not include phosphorus or other metals substituted in the framework. As used herein, “aluminosilicate zeolite” may not include aluminophosphate materials such as SAPO, AlPO, and MeAlPO materials. In some embodiments, the broader term “zeolite” includes aluminosilicates and aluminophosphates. Zeolites are crystalline materials, understood to be aluminosilicates with open 3-dimensional framework structures composed of corner-sharing TO₄ tetrahedra, where T is Al or Si. Zeolites may comprise silica to alumina (SAR) molar ratios of 1 or greater. Zeolites for use in the disclosed catalyst compositions are not limited in terms of SAR values. In some embodiments, the SAR value associated with a zeolite may affect the SCR performance of the catalyst composition into which it is incorporated (e.g., particularly after aging). In some embodiments, the SAR values of the zeolites independently are from about 2 to about 100, from about 5 to about 100, or from about 2 to about 50.

In some embodiments, the first un-promoted zeolite and the second un-promoted zeolite each may respectively have a silica-to-alumina ratio (SAR) from 5 to 100. In some embodiments, the first un-promoted zeolite and the second un-promoted zeolite have the same SAR values (e.g., selected from the range of 5 to 100). In some embodiments, the first un-promoted zeolite and the second un-promoted zeolite have different SAR values (e.g., each independently selected from the range of 5 to 100). In some embodiments, the second un-promoted zeolite has a relatively higher SAR value than the first un-promoted zeolite (e.g., each independently selected from the range of 5 to 100). In some embodiments, a higher SAR does not provide as many ion-exchange sites for the catalytic enhancement of the zeolite (e.g., the reaction of the zeolite with the metal (e.g., copper) oxide particles), meaning that the un-promoted zeolite with a higher SAR can be more stable than an un-promoted zeolite with a lower SAR.

Cations that balance the charge of the anionic framework are loosely associated with the framework oxygen of a zeolite, and the remaining pore volume may be potentially filled with water molecules. The non-framework cations may be exchangeable, and the water molecules may be removable. Zeolites may have uniform pore sizes ranging from about 3 angstroms to 10 angstroms in diameter, depending upon the type of zeolite and the type and amount of cations included in the zeolite lattice.

Molecular sieves can be classified by means of the framework topology by which the structures are identified. In some embodiments, any structure type of zeolite can be used, such as structure types chosen from ABW, ACO, AEI, AEL, AEN, AET, AFG, AFI, AFN, AFO, AFR, AFS, AFT, AFX, AFY, AHT, ANA, APC, APD, AST, ASV, ATN, ATO, ATS, ATT, ATV, AWO, AWW, BCT, BEA, BEC, BIK, BOG, BPH, BRE, CAN, CAS, SCO, CFI, SGF, CGS, CHA, CHI, CLO, CON, CZP, DAC, DDR, DFO, DFT, DOH, DON, EAB, EDI, EMT, EON, EPI, ERI, ESV, ETR, EUO, FAU, FER, FRA, GIS, GIU, GME, GON, GOO, HEU, IFR, IHW, ISV, ITE, ITH, ITW, IWR, IWW, JBW, KFI, LAU, LEV, LIO, LIT, LOS, LOV, LTA, LTL, LTN, MAR, MAZ, MEI, MEL, MEP, MER, MFI, MFS, MON, MOR, MOZ, MSO, MTF, MTN, MTT, MTW, MWW, NAB, NAT, NES, NON, NPO, NSI, OBW, OFF, OSI, OSO, OWE, PAR, PAU, PHI, PON, RHO, RON, RRO, RSN, RTE, RTH, RUT, RWR, RWY, SAO, SAS, SAT, SAV, SBE, SBS, SBT, SFE, SFF, SFG, SFH, SFN, SFO, SGT, SOD, SOS, SSY, STF, STI, STT, TER, THO, TON, TSC, UEI, UFI, UOZ, USI, UTL, VET, VFI, VNI, VSV, WIE, WEN, YUG, ZON, and combinations thereof.

In some embodiments of the present disclosure, the first un-promoted zeolite and the second un-promoted zeolite have the same framework structure. In some embodiments, the first un-promoted zeolite and the second un-promoted zeolite have different framework structures. In some embodiments, the first and/or second un-promoted zeolites can each have an “8-ring” framework structure chosen from AEI, AFT, AFV, AFX, AVL, CHA, DDR, EAB, EEI, ERI, IFY, IRN, KFI, LEV, LTA, LTN, MER, MWF, NPT, PAU, RHO, RTE, RTH, SAS, SAT, SAV, SFW, TSC, UFI, and combinations thereof. In some embodiments, the first and/or second un-promoted zeolites can each have a “10-ring” framework structure chosen from AEL, AFO, AHT, BOF, BOZ, CGF, CGS, CHI, DAC, EUO, FER, HEU, IMF, ITH, ITR, JRY, JSR, JST, LAU, LOV, MEL, MFI, MFS, MRE, MTT, MVY, MWW, NAB, NAT, NES, OBW, PAR, PCR, PON, PUN, RRO, RSN, SFF, SFG, STF, STI, STT. STW, SVR, SZR, TER, TON. TUN, UOS, VSV, WEI, WEN, and combinations thereof. In some embodiments, the first and/or second un-promoted zeolites can each have a “12-ring” framework structure chosen from AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL, MAZ, MEL MOR, MOZ, MSE, MTW, NPO, OFF, OKO, OSI, RON, RWY, SAF, SAO, SBE, SBS, SBT, SEW, SFE, SFO, SFS, SFV, SOF, SOS, STO, SSF, SSY, USI, UWY, VET and combinations thereof. In some embodiments, the first and/or second un-promoted zeolite has a CHA framework structure. Accordingly, the first zeolite and the second zeolite can be, for example, the same type of zeolite framework with the same silica-to-alumina ratio, the same type of zeolite framework with different silica-to-alumina ratio, or different zeolite frameworks.

As described above, the catalyst compositions of the present disclosure are prepared using a first un-promoted zeolite and a second un-promoted zeolite. The first and/or the second un-promoted zeolite can each be in H⁺ form, NH₄⁺ form, or a combination of these forms. In some embodiments, the first un-promoted zeolite and the second un-promoted zeolite are in hydrogen (H⁺) form. In some embodiments, the first and the second un-promoted zeolites do not contain transition metals (e.g., the first un-promoted zeolite and/or the second un-promoted zeolite are substantially free of a metal component added to the zeolite) before the components of the catalyst compositions described herein, which include the un-promoted zeolites, are mixed to form the as-made catalyst compositions of the present disclosure.

In some embodiments, the first un-promoted zeolite and the second un-promoted zeolite have the same (or comparable) particle sizes. In some embodiments, the first un-promoted zeolite and the second un-promoted zeolite have different particle sizes. In some embodiments, the first un-promoted zeolite and the second un-promoted zeolite independently each has a D90 particle size from about 2 microns to about 20 microns, or from about 5 microns to about 15 microns. In some embodiments, the first un-promoted zeolite and/or the second un-promoted zeolite each has a D90 particle size of about 20 microns or less, about 10 microns or less, or about 5 microns or less.

The disclosed catalyst compositions can be prepared with un-promoted zeolites. In some embodiments, catalyst activity is enhanced when zeolites are promoted with one or more metals. Molecular sieves (e.g., zeolites) can be metal-promoted. As used herein, “promoted” refers to a molecular sieve comprising one or more components that are being added, as opposed to comprising impurities that may be inherent in the molecular sieve. Thus, a promoter is a component that is added to enhance the activity of a catalyst, compared to a catalyst that does not have promoter added. In order to promote the SCR of oxides of nitrogen, a suitable metal can be exchanged into the molecular sieves. Copper (Cu) and iron (Fe) participate in the conversion of nitrogen oxides and thus may be useful metals for exchange. Promoter metals can be chosen from alkali metals, alkaline earth metals, transition metals in Groups IIIB, IVB, VB, VIB, VIIB, VIIIB, IB, and IIB, Group IIIA elements, Group IVA elements, lanthanides, actinides, and combinations thereof. In some embodiments, promoter metals that can be used to prepare metal-promoted molecular sieves include, but are not limited to, one or more metals chosen from copper (Cu), cobalt (Co), nickel (Ni), lanthanum (La), manganese (Mn), iron (Fe), vanadium (V), silver (Ag), cerium (Ce), neodymium (Nd), praseodymium (Pr), titanium (Ti), chromium (Cr), zinc (Zn), tin (Sn), niobium (Nb), molybdenum (Mo), hafnium (Hf), yttrium (Y), tungsten (W), and combinations thereof. Combinations of such metals can be employed, e.g., copper and iron, giving a mixed Cu—Fe-promoted molecular sieve.

In some embodiments, a promoter precursor is used to prepare the catalyst compositions described herein. For example, the promoter precursor can be present in an amount sufficient to provide a promoted zeolite with about 1 weight percent to about 15 weight percent of Cu, or about 5 weight percent to about 10 weight percent of Cu, based on the total weight of the promoted zeolite. The promoter precursor can include, for example, metal oxide(s), metal acetate(s), metal nitrate(s), metal carbonate(s), or combinations thereof. In some embodiments, the promoter precursor includes a copper compound. As described above, when mixed with an un-promoted zeolite, the promoter precursor can react with the un-promoted zeolite in situ to form a metal-promoted zeolite present in the as-made catalyst compositions of the present disclosure. In some embodiments, the first un-promoted zeolite can be promoted with about 1 weight percent to about 15 weight percent of copper, or about 5 weight percent to about 10 weight percent of copper, based on the total weight of the promoted zeolite.

### Substrate

In some embodiments, the substrate (onto which the disclosed catalyst composition is applied to give a catalytic article, e.g., an SCR catalytic article) may be constructed of any material used for preparing automotive catalysts and may include a metal or ceramic honeycomb structure. As used herein, the term “substrate” refers to a monolithic material onto which the catalyst composition is applied, in the form of a washcoat. The substrate provides a plurality of wall surfaces upon which a SCR washcoat composition (e.g., comprising the metal-promoted molecular sieve disclosed herein) is applied and adhered, thereby acting as a carrier for the catalyst composition. In some embodiments, the substrate is chosen from one or more of a flow-through honeycomb monolith and a particulate filter, and the catalytic material(s) are applied to the substrate as a washcoat.

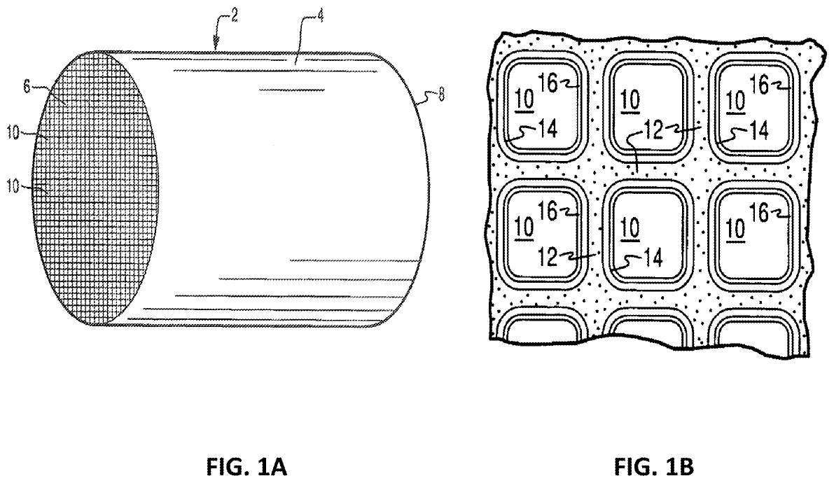

FIGS. 1A and 1B illustrate an example substrate 2 in the form of a flow-through substrate coated with a catalyst composition as described herein. Referring to FIG. 1A, the example substrate 2 has a cylindrical shape and a cylindrical outer surface 4, an upstream end face 6, and a corresponding downstream end face 8, which is identical to end face 6. Substrate 2 has a plurality of fine, parallel gas flow passages 10 formed therein. As seen in FIG. 1B, flow passages 10 are formed by walls 12 and extend through carrier 2 from upstream end face 6 to downstream end face 8, the passages 10 being unobstructed so as to permit the flow of a fluid, e.g., a gas stream, longitudinally through carrier 2 via gas flow passages 10 thereof. As more easily seen in FIG. 1B, walls 12 are so dimensioned and configured that gas flow passages 10 have a substantially regular polygonal shape. As shown, the catalyst composition can be applied in multiple, distinct layers, if desired. In the illustrated embodiment, the catalyst composition consists of both a discrete bottom layer 14 adhered to the walls 12 of the carrier member and a second discrete top layer 16 coated over the bottom layer 14. The catalyst compositions of the present disclosure can be practiced with one or more (e.g., 2, 3, 4, or more) catalyst layers and is not limited to the two-layer embodiment illustrated in FIG. 1B.

In some embodiments, the substrate is a ceramic or metal having a honeycomb structure. Any suitable substrate may be employed, such as a monolithic substrate of the type having fine, parallel gas flow passages extending there through from an inlet or an outlet face of the substrate such that passages are open to fluid flow there through. The passages, which are substantially straight paths from their fluid inlet to their fluid outlet, are defined by walls on which the catalytic material is coated as a washcoat, so that the gases flowing through the passages contact the catalytic material. The flow passages of the monolithic substrate are thin-walled channels, which can be of any suitable cross-sectional shape and size, such as trapezoidal, rectangular, square, sinusoidal, hexagonal, oval, circular, etc. Such structures may contain from about 60 to about 900 or more gas inlet openings (e.g., cells) per square inch of cross section. The wall thickness of flow-through substrates can vary, with a typical range being between 0.002 inches (50.8 microns) and 0.01 inches (254 microns). In some embodiments, a representative commercially-available flow-through substrate is a cordierite substrate having 400 cpsi and a wall thickness of 4 mil-6 mil (0.004 inch to 0.006 inch, or 101.6 microns to 152.4 microns), or 600 cpsi and a wall thickness of 3 mil-4 mil (0.003 inch to 0.004 inch, or 76.2 microns to 101.6 microns). However, it will be understood that the disclosure is not limited to a particular substrate type, material, or geometry.

Ceramic materials used to construct the substrate may include any suitable refractory material, e.g., chosen from cordierite, mullite, cordierite-α alumina, silicon carbide, aluminum titanate, silicon nitride, zircon mullite, spodumene, alumina-silica magnesia, zircon silicate, sillimanite, magnesium silicates, zircon, petalite, a alumina, aluminosilicates, and the like, and combinations thereof.

In some embodiments, the substrates for the catalyst may be metallic in nature and be composed of one or more metals or metal alloys. In some embodiments, a metallic substrate may include any metallic substrate, such as those with openings or “punch-outs” in the channel walls. Metallic substrates may be employed in various shapes such as pellets, corrugated sheet, or monolithic foam. Examples metallic substrates include heat resistant metals, and metal alloys, such as titanium and stainless steel, as well as other alloys in which iron is a substantial or major component. Such alloys may contain one or more chosen from nickel, chromium, and aluminum, and the total of these metals may comprise at least about 15 wt % of the alloy. For instance, about 10 wt % to 25 wt % chromium, about 1 wt % to 8 wt % of aluminum, and about 0 wt % to 201 wt % of nickel, in each case based on the weight of the substrate. The alloys may also contain small or trace amounts of one or more other metals, such as chosen from manganese, copper, vanadium, titanium, and the like. The surface or the metal carriers may be oxidized at high temperatures, e.g., 1000° C. and higher, to form an alumina oxide layer on the surface of the substrate, to improve the corrosion resistance of the alloy and facilitate adhesion of the washcoat layer to the metal surface.

In some embodiments where the substrate is a particulate filter, the particulate filter can be chosen from a gasoline particulate filter or a diesel soot filter. As used herein, the terms “particulate filter” or “soot filter” refer to a filter designed to remove particulate matter from an exhaust gas stream such as soot. Particulate filters can include, but are not limited to honeycomb wall flow filters, partial filtration filters, wire mesh filters, wound fiber filters, sintered metal filters, and foam filters. In some embodiments, the particulate filter is a catalyzed soot filter (CSF). The catalyzed CSF comprises, for example, a substrate coated with a catalyst composition of the disclosure. An SCR catalyst coated on a filter can be referred to as an SCRoF.

Wall flow substrates for supporting the catalyst material may have a plurality of fine, substantially parallel gas flow passages extending along the longitudinal axis of the substrate. Each passage is blocked at one end of the substrate body, with alternate passages blocked at opposite end-faces. Such monolithic substrates may contain up to about 900 or more flow passages (or “cells”) per square inch of cross section, although fewer flow passages may be used. For example, the substrate may have from about 7 cells per square inch (“cpsi”) to 600 cpsi, or from about 100 cpsi to 300 cpsi. Catalytic materials may be present on the inlet side of the substrate wall alone, the outlet side alone, both the inlet and outlet sides, or the wall itself may consist all, or in part, of the catalytic material. In some embodiment, this disclosure may include the use of one or more catalyst layers and combinations of one or more catalyst layers on the inlet, outlet, or within walls of the filter substrate.

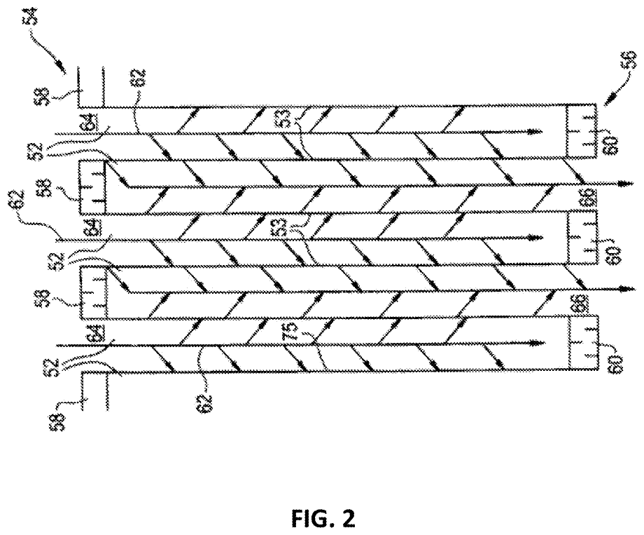

FIG. 2 illustrates a cross-sectional view of a plurality of porous walls extending longitudinally from an inlet end to an outlet end of a wall flow filter substrate, in accordance with some embodiments of the present disclosure. In some embodiments, FIG. 2 shows a partial cross-sectional view of a plurality of porous walls 53 extending longitudinally from an inlet end 54 to an outlet end 56, and forming a plurality of parallel passages 52. In some embodiments, a gas stream 62 (shown as arrows) enters through the open and unplugged end of inlet passages 64, is stopped at the closed end by outlet plug 60, and diffuses through the porous walls 53 that form the passages to the outlet passages 66. The gas stream 62 exits the filter by flowing through the open and unplugged end of outlet passages 66. In some embodiments, the gas is prevented from flowing backwards to the inlet end 54 of the filter from the outlet passages 66 by the inlet plugs 58, and prevented from re-entering the inlet passages 64 from the outlet end 56 by the outlet plugs 60. Accordingly, a number of the inlet passages are related to a number of inlet passages 64 that are open at the inlet end 54 and closed at the outlet end 56. Similarly, a number of outlet passages are related to a number of outlet passages 66 that are closed at the inlet end 54 and open at the outlet end 56, where the outlet passages are different passages than the inlet passages. The porous wall flow filter used in the disclosure can be catalyzed in that the wall of the substrate has therein or thereon one or more catalytic materials.

In some embodiments, such monolithic substrates may contain up to about 700 cpsi or more, such as about 100 cpsi to 400 cpsi or more, or about 200 cpsi to about 300 cpsi. The cross-sectional shape of the cells can vary as described above. In some embodiments, wall-flow substrates have a wall thickness between 0.008 inches (203.2 microns) and 0.02 inches (508 microns). A representative commercially available wall-flow substrate is constructed from a porous cordierite, an example of which has 200 cpsi and 10 mil (0.01 inches or 254 microns) wall thickness or 300 cpsi with 8 mil (0.008 inches or 203.2 microns) wall thickness, and wall porosity between 45%-65%. Other ceramic materials such as aluminum-titanate, silicon carbide and silicon nitride can also be used as wall-flow filter substrates. It will be understood that the present disclosure is not limited to a particular substrate type, material, or geometry. In some embodiments, where the substrate is a wall-flow substrate, the catalyst composition associated therewith can permeate into the pore structure of the porous walls (e.g., partially or fully occluding the pore openings) in addition to being disposed on the surface of the walls.

In some embodiments, the wall-flow filter article substrate may have a volume of 2.0 L, 2.5 L, 5.0 L, 10 L, 20 L, or 30 L. It is to be understood that all volumes between any two of these exemplary values is also included in the scope of the disclosure. In some embodiments, wall-flow filter substrates have a wall thickness from about 200 microns to about 500 microns. For example, wall-flow filter substrates can have a wall thickness from about 200 microns to about 300 microns.

The walls of a wall-flow filter are porous and generally have a wall porosity of at least about 45% to least about 70%, with an average pore size of at least about 5 microns to at least about 30 microns prior to disposition of the functional coating. The terms “wall porosity” and “substrate porosity” are interchangeable in the present disclosure. In some embodiments, porosity is the ratio of void volume within a portion of the filter wall divided by the volume in which the void fraction is measured. Pore size may be determined according to ISO15901-2 (static volumetric) procedure for nitrogen pore size analysis. Nitrogen pore size may be determined on Micromeritics TRISTAR 3000 series instruments. Nitrogen pore size may be determined using BJH (Barrett-Joyner-Halenda) calculations and 33 desorption points. In some embodiments, wall-flow filters with high porosity are helpful with allowing high loadings of catalyst compositions without excessive backpressure during operation.

In some embodiments, a substrate is provided with a catalyst composition comprising a first un-promoted zeolite and a second un-promoted zeolite, as disclosed herein. Such a coated substrate can, in some embodiments, exhibit enhanced NOₓ conversion with respect to a coated substrate comprising a catalyst composition without a first and a second un-promoted zeolite.

### Method of Making an SCR Composition According to the Present Disclosure

According to the present disclosure, a SCR catalyst composition is generally prepared by providing a first un-promoted molecular sieve (e.g., zeolite) material. In some embodiments, the first un-promoted zeolite and a binder (e.g., zirconium acetate) can be mixed into water to form a slurry (e.g., the catalyst slurry). A metal promoter (e.g, copper) precursor can be mixed into the catalyst coating slurry, wherein the promoter precursor includes one or more chosen from metal oxide(s), metal acetate(s), metal nitrate(s), metal formate(s), metal oxalate(s), metal sulphate(s), metal carbonate(s), and combinations thereof. In some embodiments, the promoter precursor is provided in an amount sufficient to give the desired metal promotion, e.g., an amount sufficient to provide a promoted zeolite with about 1 weight percent to about 15 weight percent metal. In some embodiments, the quantity of metal (e.g., copper) promoter precursor provides a Cu/Al molar ratio of 0.2 to 1.0, relative to the first zeolite. In some embodiments, when mixed with the first un-promoted zeolite, the promoter precursor reacts with at least a portion of the first un-promoted zeolite in situ to form a metal-promoted zeolite present in the as-made catalyst compositions of the present disclosure. In some embodiments, the mixture of the first un-promoted zeolite, the promoter precursor, and the binder are mixed and allowed to react, for about 24 hours or more.

About a day after mixing the slurry comprising the first un-promoted zeolite, the promoter precursor and the binder, a second un-promoted zeolite is added to the slurry and mixed with the other components. In some embodiments, at least a portion, e.g., a majority, of the second zeolite remains un-promoted. Accordingly, in some embodiments, the second un-promoted zeolite is added after the first zeolite. In some embodiments, the second un-promoted zeolite is added after the first zeolite and the metal in the promoter precursor have substantially reacted to form the first metal-promoted zeolite. In some embodiments, the exact amount of metal-promoted zeolite formed via this process is difficult to quantify and may reasonably be expected to range from a portion of zeolites being promoted up to complete promotion, e.g., with little or no metal component remaining in the mixture which has not reacted with the first zeolite. In some embodiments, a majority of the second un-promoted zeolite in the final catalyst composition remains un-promoted with a metal.

### Substrate Coating Process

In some embodiments, as referenced above, the catalyst composition is prepared and coated on a substrate. This method can comprise mixing a catalyst composition (or one or more components of the catalyst composition) as disclosed herein with a solvent (e.g., water) to form a slurry for purposes of coating a catalyst substrate. A catalyst composition comprising the first metal-promoted zeolite (e.g., formed from a first un-promoted zeolite and a promoter precursor reacting in situ) and a second un-promoted zeolitic material as described herein can be prepared in the form of a slurry.

In some embodiments, in addition to the catalyst component(s) (e.g., the first metal-promoted zeolite formed from a first un-promoted zeolite and a promoter precursor reacting in situ, and a second un-promoted zeolitic material), the slurry may optionally contain various additional components. In some embodiments, additional components include, but are not limited to, one or more binders and additives to control one or more characteristics, e.g., pH and viscosity, of the slurry. In some embodiments, the additional components can include binders (e.g., one or more chosen from silica, titania, zirconia, alumina, and a combination thereof, in an amount of about 0.1 weight percent to about 20 weight percent, based on the weight of the zeolite), associative thickeners, and/or surfactants (e.g., one or more chosen from anionic, cationic, non-ionic, or amphoteric surfactants).

In some embodiments, the slurry can be milled to enhance mixing of the particles and formation of a homogenous washcoat. In some embodiments, the milling can be accomplished in a ball mill, continuous mill, or other similar equipment. In some embodiments, the solids content of the slurry may be, e.g., about 20 wt %-60 wt %, more particularly, about 30 wt %-40 wt %. In some embodiments, the post-milling slurry is characterized by a D₉₀ particle size of about 5 microns to about 50 microns (e.g., about 5 microns to about 20 microns, or about 10 microns to about 20 microns).

In some embodiments, the slurry is coated on the catalyst substrate using a suitable washcoat technique. In some embodiments, the term “washcoat” refers to a thin, adherent coating of a material (e.g., a catalytic material) applied to a substrate, such as a honeycomb flow-through monolith substrate, or a filter substrate, which is sufficiently porous to permit the passage therethrough of the gas stream being treated. As used herein and as described in Heck, Ronald and Robert Farrauto, Catalytic Air Pollution Control, New York: Wiley-Interscience, 2002, pp. 18-19, a washcoat layer includes a compositionally distinct layer of material disposed on the surface of a monolithic substrate or on an underlying washcoat layer. A substrate can contain one or more washcoat layers, and each washcoat layer can have unique chemical catalytic functions.

In some embodiments, a washcoat is formed by preparing a slurry containing solid content (e.g., 30%-60% by weight) of catalyst material (e.g., the first metal-promoted zeolite formed from a first un-promoted zeolite and a promoter precursor reacting in situ, and a second un-promoted zeolitic material) in a liquid vehicle, which is then coated onto the substrate (or multiple substrates) and dried to provide a washcoat layer. For flow-through substrates, the resulting washcoat layer is evenly distributed on all substrate walls. For filter substrates, the catalyst slurry permeates the walls of the substrate, yet the pores are not occluded to the extent that undue back pressure will build up in the finished substrate. As used herein, the term “permeate,” when used to describe the dispersion of the catalyst slurry on and into the filter substrate, means that the catalyst composition is dispersed throughout the wall of the substrate.

Thereafter, the coated substrate is dried at an elevated temperature (e.g., 100° C.-150° C.) for a period of time (e.g., 10 min-3 hours) and then calcined by heating, e.g., at 400° C.-600° C., for about 10 minutes to about 3 hours. Following drying and calcining, the final washcoat coating layer can be viewed as essentially solvent-free.

After calcining, the catalyst loading can be determined through calculation of the difference in coated and uncoated weights of the substrate. As can by understood by those of skill in the art, the catalyst loading can be modified by altering the slurry rheology. In addition, the coating/drying/calcining process can be repeated as needed to build the coating to the desired loading level or thickness.

In some embodiments, the weight ratio of the first un-promoted zeolite to the second un-promoted zeolite, based on the total weight of the catalyst composition, is in the range of about 1:0.05 to about 1:1. In some embodiments, the weight ratio of the first un-promoted zeolite to the second un-promoted zeolite, based on the total weight of the catalyst composition, is in the range of about 1:0.1 to about 1:0.3. In some embodiments, the total amount of the first un-promoted zeolite and the second un-promoted zeolite used to prepare the catalyst composition is in a range from about 1.0 g/in³ (e.g., about 0.061 g/cm³) to about 5.0 g/in³ (e.g., about 0.305 g/cm³).

Aging can be conducted under various conditions. As used herein, “aging” is understood to encompass a range of conditions (e.g., temperature, time, atmosphere). Example aging protocols involve subjecting the calcined coated substrate to a temperature of about 650° C. for about 50 hours in 10% steam, or to a temperature of 800° C. for about 16 hours in 10% steam. However, these protocols are not intended to be limiting and the temperature can be lower or higher (e.g., including but not limited to, at temperatures of 400° C. and higher, or e.g., in a range from 400° C. to 1000° C., 600° C. to 950° C., or 650° C. to 800° C.). The time for aging may be lesser or greater (e.g., including but not limited to, times of about 1 hour to about 1000 hours, or about 2 hours to about 50 hours). The atmosphere can be modified (e.g., to have different amounts of steam and/or other constituents present therein).

### Catalyst Articles

The resulting catalyst articles (e.g., comprising one or more washcoat layers on a substrate, providing a substrate coated with a catalyst composition) can have various configurations. In some embodiments, as referenced herein, all components of the disclosed catalyst composition (e.g., including the metal-promoted zeolitic material formed from a first un-promoted zeolite and promoter precursor that can react in situ to form the metal-promoted zeolitic material, and the second un-promoted zeolitic materials) are contained within a catalyst composition washcoat layer (e.g., a mixture), which is provided as one or more layers on the substrate. In some embodiments, a catalyst article is provided with the catalyst composition coated on the substrate and comprising separate washcoat layers, wherein at least one washcoat layer comprises the metal-promoted zeolitic material formed from a first un-promoted zeolite and promoter precursor that can react in situ to form the metal-promoted zeolitic material described herein, and at least one (e.g., separate) washcoat layer includes the second un-promoted zeolite component according to the present disclosure. In some embodiments, a catalyst article is provided where the catalyst composition coated on the substrate comprises separate washcoat layers, where at least one washcoat layer comprises the metal-promoted zeolite formed from a first un-promoted zeolite and promoter precursor that can react in situ to form the metal-promoted zeolite, and the second un-promoted zeolite described herein, and at least one (e.g., separate) washcoat layer does not include the metal-promoted zeolite formed from a first un-promoted zeolite and promoter precursor that can react in situ to form the metal-promoted zeolite, and the second un-promoted zeolite according to the present disclosure. In this embodiment, the other washcoat layer may contain a PGM, e.g., Pt, and together with the metal-promoted zeolite of the present disclosure, this combination can function as a selective ammonia oxidation catalyst (AMOx).

In some embodiments, a first catalyst composition washcoat layer, comprising the metal-promoted zeolite formed from a first un-promoted zeolite and promoter precursor that can react in situ to form the metal-promoted zeolite, and the second un-promoted zeolite of the present disclosure, is directly in contact with the substrate. In some embodiments, one example catalytic article comprises a substrate having a washcoat layer containing a first metal-promoted zeolite (e.g., prepared from a first un-promoted zeolite and copper oxide material reacted in situ), and second un-promoted zeolite, and the washcoat layer is disposed directly on the surface thereof at a loading of 0.2 g/in³ (e.g., 0.012 g/cm³) to 2.0 g/in³ (e.g., 0.122 g/cm³).

The washcoat(s) can be applied such that different coating layers may be in direct contact with the substrate. In some embodiments, one or more “undercoats” may be present, so that at least a portion of a catalyst composition washcoat layer or layers are not in direct contact with the substrate (e.g., these portions may be in contact with the undercoat). One or more “overcoats” may also be present, so that at least a portion of the coating layer or layers are not directly exposed to a gaseous stream or atmosphere (e.g., these portions may be in contact with the overcoat).

In some embodiments, the resulting catalytic articles, comprising a catalyst composition as disclosed herein on a substrate, can exhibit improved NOₓ conversion and reduced N₂O formation at high temperatures without compromising low-temperature NOₓ conversion.

### Emission Treatment System

In some embodiments, selective reduction of nitrogen oxides utilizing catalyst compositions according to the present disclosure is carried out in the presence of ammonia or urea. In some embodiments, an SCR system including a catalyst composition prepared according to the methods described herein can be integrated in the exhaust gas treatment system of a vehicle. In some embodiments, an example SCR system can include the following components: an SCR catalyst composition as described herein; a urea storage tank; a urea pump; a urea dosing system; a urea injector/nozzle; and a respective control unit.

In some embodiments, the present disclosure also discloses a method for selectively reducing nitrogen oxides (NOₓ) from a stream, such as an exhaust gas. In particular, the stream can be contacted with a catalyst composition prepared according to the present disclosure. The term nitrogen oxides, or NOₓ, as used herein encompasses any type of oxides of nitrogen, including but not limited to N₂O, NO, N₂O₃, NO₂, N₂O₄, N₂O₅, and NO₃.

In some embodiments, a catalyst composition as described herein can be effective to provide a NOₓ conversion of at least 60%, at least 70%, at least 80%, at least 90%, at least 95%, or at least 99%, over a temperature range of about 150° C. to about 650° C., about 200° C. to about 600° C., about 300° C. to about 600° C., about 300° C. to about 550° C., about 300° C. to about 500° C., or about 350° C. to about 450° C. In some articular embodiments, a catalyst composition can provide a NOₓ conversion of at least about 25%, at least about 30%, or at least about 50% at 200° C. It is noted that NOₓ conversion can be dependent on testing conditions, such as space velocity.

The present disclosure also provides an emission treatment system that incorporates the SCR composition or article described herein. In some embodiments, the SCR composition of the present disclosure is used in an integrated emissions treatment system comprising one or more additional components for the treatment of diesel exhaust gas emissions. As such, the terms “exhaust stream”, “engine exhaust stream”, “exhaust gas stream” and the like refer to the engine effluent as well as to the effluent upstream or downstream of one or more other catalyst system components as described herein. Such additional catalytic components include, but are not limited to, diesel oxidation catalysts (DOCs), catalyzed soot filters (CSFs), lean NOₓ traps (LNTs), and selective NH₃ control catalysts (AMOx).

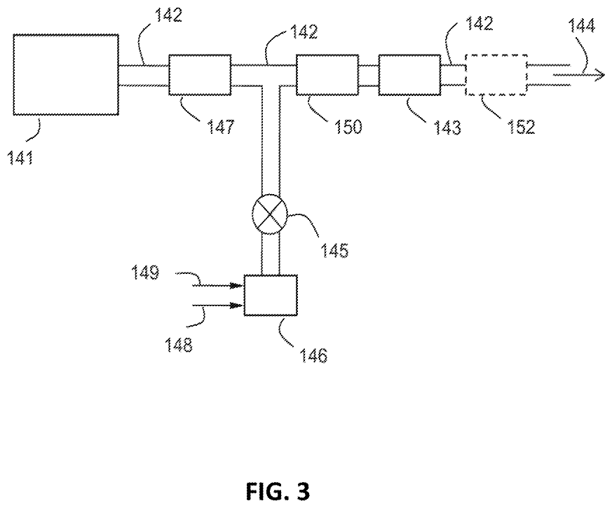

FIG. 3 illustrates one example embodiment of an engine system comprising an emission treatment system, a urea injector, and other engine components. SCR (e.g., SCRoF) catalyst 150 as disclosed herein can be disposed directly downstream of the engine (e.g., an engine 141), or can be downstream from another catalyst component, shown here as optional component 147. An optional additional catalyst 143 can be disposed downstream of the SCR catalyst 150, and may contain an AMOx catalyst, another SCR catalyst, and/or a catalyst to oxidize hydrocarbons and carbon monoxide. Depending on the desired level of ammonia, carbon monoxide and hydrocarbon removal, additional oxidation catalysts can be included. In some embodiments, an additional Cu-zeolite SCR catalyst, or a Cu-CHA SCR catalyst, may be added after the catalyst compositions disclosed in this disclosure. Either the front SCR catalyst or the rear SCR catalyst may be applied to a soot filter forming a SCRoF. The exhaust containing gaseous pollutants (e.g., including unburned hydrocarbons, carbon monoxide, and NOₓ) and particulate matter is conveyed from the engine 141 through a connector 142 to the various components shown in FIG. 3. The exhaust gas exits the system via the tailpipe 144. It is understood that other components, in addition to those shown in FIG. 3 can be included, upstream or downstream of SCR 150, e.g., another optional catalyst component 152.

The system shown in FIG. 3 further shows injection of a reductant, for example urea, which may be injected as a spray via a nozzle (not shown) into the exhaust stream. Aqueous urea shown on one line 148 may serve as the ammonia precursor which can be mixed with air on another line 149 in a mixing station 146. Valve 145 can be used to meter precise amounts of aqueous urea which are converted in the exhaust stream to ammonia. The exhaust stream with the added ammonia is conveyed to the SCR catalyst 150 for the SCR reaction. The injector shown is an example of one type of system that can be used, and other variants are within the scope of the disclosure.

### EXAMPLES

Aspects of the present disclosure are further illustrated by the following examples, which are set forth to illustrate certain aspects of the present disclosure and are not to be construed as limiting thereof.

### Example 1

A first slurry containing Chabazite-A having a silica to alumina ratio (SAR) of 19, CuO in a quantity sufficient to produce 3.7% CuO of the total quantity of zeolite and CuO, zirconium acetate, and deionized water was milled to a target particle size of D90 2 microns-20 microns. The first slurry was mixed for 24 hours at room temperature to allow copper ions to exchange into the zeolite framework.

A second slurry containing Chabazite-B having a silica to alumina ratio of 26 and deionized water was milled to a target particle size.

The second slurry was mixed into the first slurry. The weight ratio of Chabazite-A and Chabazite-B was 1:0.2. The final slurry was coated onto cellular ceramic monoliths having a cell density of 400 cpsi and a wall thickness of 6 mil (e.g., 0.006 inch or 152.4 microns), followed by drying at 130° C., and calcination at 550° C. for 1 hour.

### Comparative Example 1

A slurry containing Chabazite-A having a silica to alumina ratio of 19, CuO in a quantity sufficient to produce 3.7% CuO of the total quantity of zeolite and CuO, zirconium acetate, and deionized water was milled to a target particle size of D90 2 microns-20 microns. The slurry was mixed for 24 hours at room temperature to allow copper ions to exchange into the zeolite framework. The slurry was coated onto cellular ceramic monoliths having a cell density of 400 cpsi and a wall thickness of 6 mil (e.g., 0.006 inch or 152.4 microns), followed by drying at 130° C., and calcination at 550° C. for 1 hour.

NOₓ conversions and N₂O selectivity of Example 1 and Comparative Example 1 were measured at a gas hourly volume-based space velocity of 80,000 h⁻¹ under pusedo-steady state conditions in a gas mixture of 500 ppm NO, 525 ppm NH₃, 10% O₂, 10% H₂O, balance N₂ in a temperature range from 200° C. to 600° C. NOₓ conversion was reported as mol % and measured as NO and NO₂. N₂O selectivity was reported as mol % and measured as follows:

$${N}_{2} O Selectivity ( \% ) = \frac{{N}_{2} O \div 2 \times 100 \%}{( NO + {NO}_{2} + {NH}_{3} ) inlet - ( NO + {NO}_{2} + {NH}_{3} + {N}_{2} O \div 2 ) outlet}$$

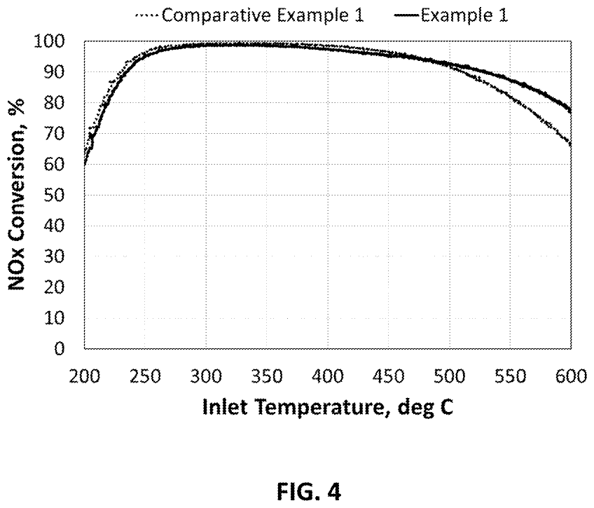

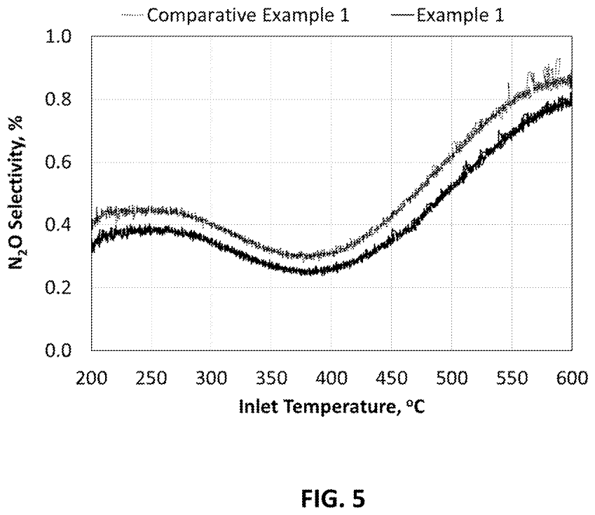

The samples were hydrothermally aged at 800° C. for 16 hours in the presence of 10% steam before testing. NOₓ conversion and N₂O selectivity of Example 1 and Comparative Example 1 are shown in FIGS. 4 and 5. FIG. 4 depicts a graph of NOₓ conversion over a range of temperatures for the SCR catalyst samples according to Example 1 and for the SCR catalyst samples according to Comparative Example 1. FIG. 5 depicts a graph of N₂O formation over a range of temperatures for the catalyst samples according to Example 1 and for the SCR catalyst samples according to Comparative Example 1. As illustrated in FIGS. 4 and 5, the catalytic article prepared according to Example 1 provided improved high-temperature NOₓ conversion and reduced N₂O formation, without compromising low-temperature NOₓ conversion, as compared with Comparative Example 1, which does not have the second, un-promoted zeolite.

### Example 2

A first slurry containing Chabazite-A having a silica to alumina ratio of 19, CuO in a quantity sufficient to produce 5.2% CuO over the total quantity of zeolite and CuO, zirconium acetate, and deionized water was milled to a target particle size of D90 2 microns-20 microns. The first slurry was mixed for 24 hours at room temperature to allow copper ions to exchange into the zeolite framework.

A second slurry containing Chabazite-A and deionized water was milled to a target particle size.

The second slurry was mixed into the first slurry. The weight ratio of Chabazite-A in the first slurry and Chabazite-A in the second slurry was 1:0.1. The final slurry was coated onto cellular ceramic monoliths having a cell density of 400 cpsi and a wall thickness of 6 mil (e.g., 0.006 inch or 152.4 microns), followed by drying at 130° C., and calcination at 550° C. for 1 hour.

### Comparative Example 2

A slurry containing Chabazite-A having a silica to alumina ratio of 19, CuO in a quantity sufficient to produce 5.2% CuO over the total quantity of zeolite and CuO, zirconium acetate, and deionized water was milled to target particle size of D90 2 microns-20 microns. The slurry was mixed for 24 hours at room temperature to allow copper ions to exchange into the zeolite framework. The slurry was coated onto cellular ceramic monoliths having a cell density of 400 cpsi and a wall thickness of 6 mil (e.g., 0.006 inch or 152.4 microns), followed by drying at 130° C., and calcination at 550° C. for 1 hour.

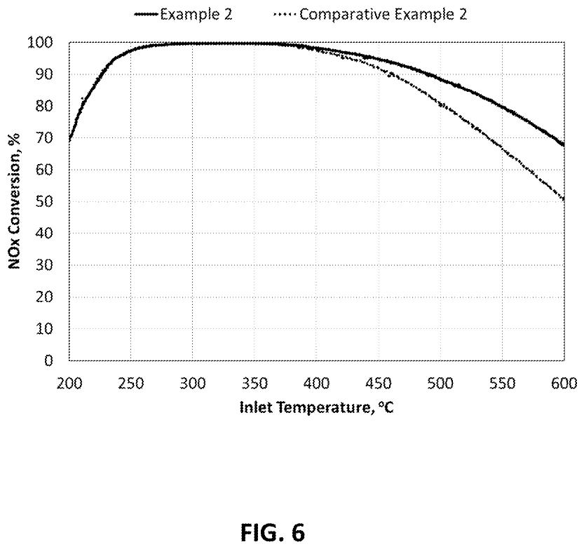

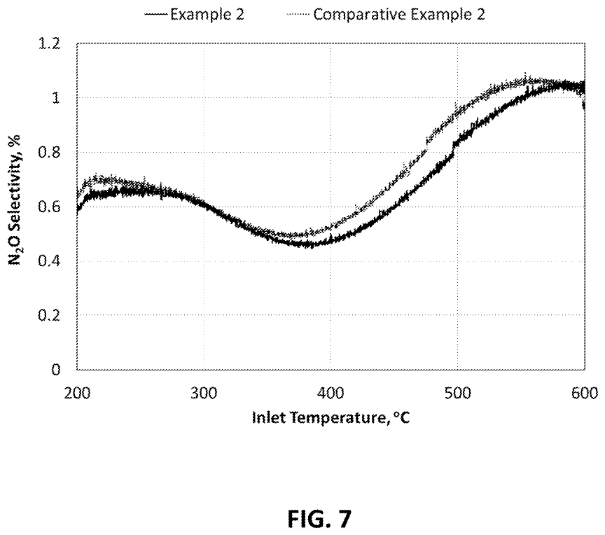

NOₓ conversions and N₂O selectivity of Example 2 and Comparative Example 2 were measured according to the same method described above for Example 1 and Comparative Example 1. The samples were hydrothermally aged at 800° C. for 16 hours in the presence of 10% steam before testing. NOₓ conversion and N₂O selectivity of Example 1 and Comparative Example 1 are shown in FIGS. 6 and 7. FIG. 6 is a graph of NOₓ conversion over a range of temperatures for the SCR catalyst samples according to Example 2 and for the SCR catalyst samples according to Comparative Example 2. FIG. 7 is a graph of N₂O formation over a range of temperatures for the catalyst samples according to Example 2 and for the SCR catalyst samples according to Comparative Example 2. As illustrated in FIGS. 6 and 7, the catalytic article prepared according to Example 2 provided improved high-temperature NOₓ conversion and reduced N₂O formation, without compromising low-temperature NOₓ conversion, as compared with Comparative Example 2, which does not have the second un-promoted zeolite.

According to the present disclosure, the use of the two separate un-promoted zeolites in the catalyst compositions can trap CuOx clusters (e.g., which reduce high-temperature NOₓ conversion), and allow for reaction of the CuOx clusters with the un-promoted zeolite for enhanced SCR activity. As described above, during preparation of the catalyst compositions, the first un-promoted zeolite can react with the promoter precursor in situ to form a metal-promoted zeolite with a relatively low amount of CuOₓ clusters. That is, the first zeolite can react with CuO during catalyst preparation. The second un-promoted zeolite present in the catalyst compositions can be effective to trap metal oxide clusters that form under hydrothermal conditions. For example, the second zeolite functions as a CuOₓ trap during hydrothermal aging. The CuOx described here is different from the CuO used in catalyst preparation (e.g., which has a low surface area and low NH₃ oxidation activity). CuOₓ clusters generated during hydrothermal aging are active for NH₃ oxidation, which reduces high temperature NOₓ conversion.

### EXAMPLE EMBODIMENTS

Without limitation, some embodiments of the present disclosure include:

1. A method of forming a selective catalytic reduction (SCR) catalyst composition, comprising:

mixing a first un-promoted zeolite with a promoter precursor, wherein the first un-promoted zeolite and the promoter precursor react in situ to form a metal-promoted zeolite; and

mixing the metal-promoted zeolite with a second un-promoted zeolite to form the catalyst composition.

2. The method of Embodiment 1, wherein the first un-promoted zeolite and the second un-promoted zeolite are both in hydrogen-form.

3. The method of Embodiment 1, wherein the first un-promoted zeolite and the second un-promoted zeolite are both in ammonium-form.

4. The method of Embodiment 1, wherein one of the first un-promoted zeolite and the second un-promoted zeolite is in hydrogen-form and the other of the first un-promoted zeolite and the second un-promoted zeolite is in ammonium-form.

5. The method composition of any one of Embodiments 1-4, wherein the first un-promoted zeolite and the second un-promoted zeolite do not contain transition metals.

6. The method of any one of Embodiments 1-5, wherein the first un-promoted zeolite and the second un-promoted zeolite have the same framework structure.

7. The method of any one of Embodiments 1-5, wherein the first un-promoted zeolite and the second un-promoted zeolite have different framework structures.

8. The method of any one of Embodiments 1-7, wherein at least one of the first un-promoted zeolite and the second un-promoted zeolite has a CHA framework structure.

9. The method of any one of Embodiments 1-7, wherein at least one of the first un-promoted zeolite and the second un-promoted zeolite has an “8-ring” framework structure chosen from AEI, AFT, AFV, AFX, AVL, CHA, DDR, EAB, EEI, ERI, IFY, IRN, KFI, LEV, LTA, LTN, MER, MWF, NPT, PAU, RHO, RTE, RTH, SAS, SAT, SAV, SFW, TSC, UFI, and combinations thereof.

10. The method of any one of Embodiments 1-7, wherein at least one of the first un-promoted zeolite and the second un-promoted zeolite has a “10-ring” framework structure chosen from AEL, AFO, AHT, BOF, BOZ, CGF, CGS, CHI, DAC, EUO, FER, HEU, IMF, ITH, ITR, JRY, JSR, JST, LAU, LOV, MEL, MFI, MFS, MRE, MTT, MVY, MWW, NAB, NAT, NES, OBW, PAR, PCR, PON, PUN, RRO, RSN, SFF, SFG, STF, STI, STT, STW, SVR, SZR, TER, TON, TUN, UOS, VSV, WEI, WEN, and combinations thereof.

11. The method of any one of Embodiments 1-7, wherein at least one of the first un-promoted zeolite and the second un-promoted zeolite has a “12-ring” framework structure chosen from AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL, MAZ, MEL, MOR, MOZ, MSE, MTW, NPO, OFF, OKO, OSI, RON, RWY, SAF, SAO, SBE, SBS, SBT, SEW, SFE, SFO, SFS, SFV, SOF, SOS, STO, SSF, SSY, USI, UWY, VET and combinations thereof.

12. The method of any one of Embodiments 1-1l, wherein the first un-promoted zeolite has a first silica-to-alumina ratio (SAR) from about 2 to about 50, and wherein the second un-promoted zeolite has a second silica-to-alumina ratio (SAR) from about 2 to about 50.

13. The method of any one of Embodiments 1-12, wherein the first SAR and the second SAR are the same.

14. The method of any one of Embodiments 1-12, wherein the first SAR and the second SAR are different.

15. The method of any one of Embodiments 1-14, wherein the first un-promoted zeolite has a first D90 particle size of about 2 microns to about 20 microns, and wherein the second un-promoted zeolite has a second D90 particle size of about 2 microns to about 20 microns.

16. The method of any one of Embodiments 1-15, wherein the first D90 particle size is the same as the second D90 particle size.

17. The method of any one of Embodiments 1-15, wherein the first D90 particle size is different from the second D90 particle size.

18. The method of any one of Embodiments 1-17, wherein the first un-promoted zeolite and the second un-promoted zeolite are present with a weight ratio ranging from about 1:0.05 to about 1:1.

19. The method of any one of Embodiments 1-18, wherein the first un-promoted zeolite and the second un-promoted zeolite are present in the catalyst composition in a total amount ranging from about 1.0 g/in³ to about 5.0 g/in³.

20. The method of any one of Embodiments 1-19, wherein the promoter precursor comprises at least one chosen from copper oxide, copper acetate, copper nitrate, copper formate, copper oxalate, copper sulphate, and copper carbonate basic.

21. A catalytic article comprising a catalyst composition prepared according to the method of any one of Embodiments 1-20, wherein the catalyst composition is disposed on a flow-through honeycomb substrate or a wall-flow filter substrate.

22. An engine exhaust gas treatment system comprising a catalyst composition prepared according to the method of any one of Embodiments 1-20, and an exhaust gas conduit in fluid communication with a lean burn engine, wherein the catalyst composition is downstream of the exhaust gas conduit.

23. The engine exhaust gas treatment system of Embodiment 22, wherein the engine is a diesel engine.

24. The engine exhaust gas treatment system of Embodiment 22, wherein the catalyst composition is downstream of a DOC or CSF catalyst, wherein the system optionally further comprises a downstream SCR catalyst or an ammonia oxidation catalyst (AMOx), and wherein the downstream SCR catalyst or the AMOx catalyst comprises Cu-CHA.

25. A method of removing nitrogen oxides from exhaust gas from a lean burn engine, the method comprising contacting an exhaust gas stream from a lean burn engine with a catalyst composition prepared according to the method of any one of Embodiments 1-20.

26. A method of preparing a selective catalytic reduction (SCR) catalyst composition according to the method of any one of Embodiments 1-20.

27. A selective catalytic reduction (SCR) catalyst composition, comprising:

a metal-promoted zeolite prepared from a first un-promoted zeolite having a first silica-to-alumina ratio (SAR) from about 2 to about 50 and reacts in situ with a promoter precursor; and

a second un-promoted zeolite having a second silica-to-alumina ratio (SAR) from about 2 to about 50.

While the disclosure herein disclosed has been described by means of specific embodiments and applications thereof, numerous modifications and variations could be made thereto by those skilled in the art without departing from the scope of the disclosure set forth in the claims. Furthermore, various aspects of the disclosure may be used in other applications than those for which they were specifically described herein.

1. A method of forming a selective catalytic reduction (SCR) catalyst composition, comprising:
mixing a first un-promoted zeolite with a promoter precursor, wherein the first un-promoted zeolite and the promoter precursor react in situ to form a metal-promoted zeolite; and
mixing the metal-promoted zeolite with a second un-promoted zeolite to form the catalyst composition.

2. The method of claim 1, wherein the first un-promoted zeolite and the second un-promoted zeolite are both in hydrogen-form or are both in ammonium-form, wherein one of the first un-promoted zeolite and the second un-promoted zeolite is in hydrogen-form and the other of the first un-promoted zeolite and the second un-promoted zeolite is in ammonium-form.

3.-4. (canceled)

5. The method composition of claim 1, wherein the first un-promoted zeolite and the second un-promoted zeolite do not contain transition metals.

6. The method of claim 1, wherein the first un-promoted zeolite and the second un-promoted zeolite have the same framework structure or have different framework structures.

7. (canceled)

8. The method of claim 1, wherein at least one of the first un-promoted zeolite and the second un-promoted zeolite has a CHA framework structure.

9. The method of claim 1, wherein at least one of the first un-promoted zeolite and the second un-promoted zeolite has an “8-ring” framework structure chosen from AEI, AFT, AFV, AFX, AVL, CHA, DDR, EAB, EEI, ERI, IFY, IRN, KFI, LEV, LTA, LTN, MER, MWF, NPT, PAU, RHO, RTE, RTH, SAS, SAT, SAV, SFW, TSC, UFI, and combinations thereof.

10. The method of claim 1, wherein at least one of the first un-promoted zeolite and the second un-promoted zeolite has a “10-ring” framework structure chosen from AEL, AFO, AHT, BOF, BOZ, CGF, CGS, CHI, DAC, EUO, FER, HEU, IMF, ITH, ITR, JRY, JSR, JST, LAU, LOV, MEL, MFI, MFS, MRE, MTT, MVY, MWW, NAB, NAT, NES, OBW, PAR, PCR, PON, PUN, RRO, RSN, SFF, SFG, STF, STI, STT, STW, SVR, SZR, TER, TON, TUN, UOS, VSV, WEI, WEN, and combinations thereof.

11. The method of claim 1, wherein at least one of the first un-promoted zeolite and the second un-promoted zeolite has a “12-ring” framework structure chosen from AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL, MAZ, MEI, MOR, MOZ, MSE, MTW, NPO, OFF, OKO, OSI, RON, RWY, SAF, SAO, SBE, SBS, SBT, SEW, SFE, SFO, SFS, SFV, SOF, SOS, STO, SSF, SSY, USI, UWY, VET and combinations thereof.

12. The method of claim 1, wherein the first un-promoted zeolite has a first silica-to-alumina ratio (SAR) from about 2 to about 50, and wherein the second un-promoted zeolite has a second silica-to-alumina ratio (SAR) from about 2 to about 50, or wherein the first SAR and the second SAR are the same, or, wherein the first SAR and the second SAR are different.

13.-14. (canceled)

15. The method of claim 1, wherein the first un-promoted zeolite has a first D90 particle size of about 2 microns to about 20 microns, and wherein the second un-promoted zeolite has a second D90 particle size of about 2 microns to about 20 microns, or wherein the first D90 particle size is the same as the second D90 particle size, or wherein the first D90 particle size is different from the second D90 particle size.

16.-17. (canceled)

18. The method of claim 1, wherein the first un-promoted zeolite and the second un-promoted zeolite are present with a weight ratio ranging from about 1:0.05 to about 1:1.

19. The method of claim 1, wherein the first un-promoted zeolite and the second un-promoted zeolite are present in the catalyst composition in a total amount ranging from about 1.0 g/in³ to about 5.0 g/in³.

20. The method of claim 1, wherein the promoter precursor comprises at least one chosen from copper oxide, copper acetate, copper nitrate, copper formate, copper oxalate, copper sulphate, and copper carbonate basic.

21. A catalytic article comprising a catalyst composition prepared according to the method of claim 1, wherein the catalyst composition is disposed on a flow-through honeycomb substrate or a wall-flow filter substrate.

22. An engine exhaust gas treatment system comprising a catalyst composition prepared according to the method of claim 1, and an exhaust gas conduit in fluid communication with a lean burn engine, wherein the catalyst composition is downstream of the exhaust gas conduit.

23. The engine exhaust gas treatment system of claim 22, wherein the engine is a diesel engine.

24. The engine exhaust gas treatment system of claim 22, wherein the catalyst composition is downstream of a DOC or CSF catalyst, wherein the system optionally further comprises a downstream SCR catalyst or an ammonia oxidation catalyst (AMOx), and wherein the downstream SCR catalyst or the AMOx catalyst comprises Cu-CHA.

25. A method of removing nitrogen oxides from exhaust gas from a lean burn engine, the method comprising contacting an exhaust gas stream from a lean burn engine with a catalyst composition prepared according to the method of claim 1.

26. A method of preparing a selective catalytic reduction (SCR) catalyst composition according to the method of claim 1.

27. A selective catalytic reduction (SCR) catalyst composition, comprising: a metal-promoted zeolite prepared from a first un-promoted zeolite having a first silica-to-alumina ratio (SAR) from about 2 to about 50 and reacts in situ with a promoter precursor; and a second un-promoted zeolite having a second silica-to-alumina ratio (SAR) from about 2 to about 50.
